(19) United States
(12) Patent Application Publication
(10) Pub. No.: US 2013/0067415 A1
(43) Pub. Date: Mar. 14, 2013

(54) INTERACTIVE SELECTION OF ENTITIES BASED ON DESIRED CRITERIA

(71) Applicant: Nagaraj Mohan Hunur, (US)

(72) Inventor: Nagaraj Mohan Hunur, (US)

(21) Appl. No.: 13/228,492

(22) Filed: Sep. 9, 2011

(51) Int. Cl. G06F 3/048

(52) U.S. Cl. 715/841

(57) ABSTRACT

Interactive selection of entities. In one embodiment, a server system sends data representing categories, which are displayed on a user interface provided in a client system. The client system enables user to select desired categories using the user interface. The server system updates the match count for each sub-category of the selected categories. User then constructs the desired search criteria by including sub-categories (along with associated operators) to construct eligibility criteria. The server system identifies entities matching the search criteria, in response to receiving a search instruction (containing the search criteria).

### BACKGROUND OF THE INVENTION

1. Technical Field

The present disclosure relates to digital processing systems, and more specifically to interactive selection of entities based on desired criteria.

2. Related Art

There is often a need to select only some of many entities based on desired criteria. For example, large enterprises (e.g., corporations) often employ benefits management systems, in which only employees meeting a specific criteria (e.g., employees at a certain management level or above) may need to chosen for conferring a specific benefit (e.g., only managers and higher level employees may be given a specific bonus). While the description herein is provided substantially with respect to selection of people, entities can be other types of things such as physical objects or electronic resources, etc.

Many applications are designed to enable such selection interactively. Interactivity implies that a user provides inputs to the application, examines the output provided by the application, and continues specifying the selection criteria based on what was received as output for corresponding inputs. Interactivity typically provides enhanced control to users and is thus considered beneficial.

It is generally desirable that such interactive selection be convenient and user-friendly for use by various users.

### BRIEF DESCRIPTION OF THE DRAWINGS

Example embodiments of the present invention will be described with reference to the accompanying drawings briefly described below.

FIG. 1 is a block diagram illustrating an example environment in which several aspects of the present invention can be implemented.

FIG. 2 is a flow chart illustrating the manner in which selection of entities is performed according to an aspect of the present invention.

FIGS. 3-7 together illustrate the user interface provided for interactive selection of entities (people) in an embodiment.

FIG. 8 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

1. Overview

An aspect of the present invention facilitates selection of entities. In one embodiment, a server system sends data representing categories, which are displayed on a user interface provided in a client system. The client system enables user to select desired categories using the user interface. The server system updates the match count for each sub-category of the selected categories. User then constructs the desired search criteria by including sub-categories (along with associated operators) to construct eligibility criteria. The server system identifies entities matching the search criteria, in response to receiving a search instruction (containing the search criteria).

By having access to the match count for each sub-category, the user may be able to make more informed decisions in forming the search criteria interactively.

In an embodiment, the search criteria corresponds to eligibility criteria in a benefits management system. Thus, a user may construct eligibility criteria according to several aspects of the present invention. The different eligibility criteria thus formed may be used to identify a corresponding set of employees, and benefits may be conferred (or excluded) on such identified set of employees. The selection capability thus provided, has enhanced importance as the number of categories and sub-categories becomes large, particularly in complex large enterprises.

Another aspect of the present invention enables the match count (for sub-categories of selected categories) to be provided to the client systems quickly. Such a feature may be obtained by pre-computing and storing (in a data store) the respective match counts of at least some of the sub-categories. Accordingly, when a search request is received, the match count need not be derived/computed after the search request is received, and thus the response to the search request may be sent quickly.

Several aspects of the present invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

2. Example Environment

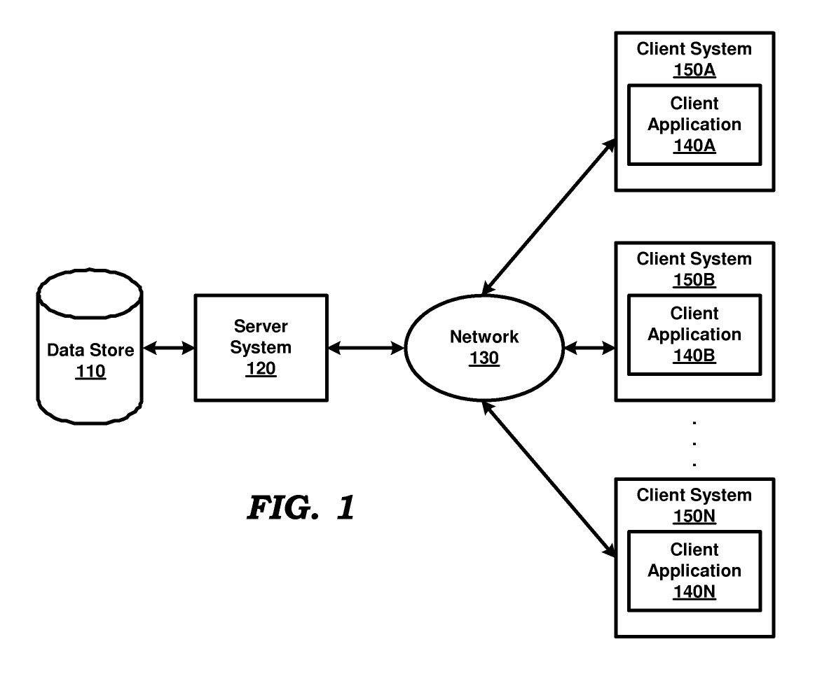

FIG. 1 is a block diagram illustrating an example environment in which several aspects of the present invention can be implemented. The block diagram is shown containing client systems 150A-150N, network 130, server system 120 and data store 110.

Merely for illustration, only representative number/type of systems is shown in FIG. 1. Many environments often contain many more systems (e.g., more server systems), both in number and type, depending on the purpose for which the environment is designed. Each system/device of FIG. 1 is described below in further detail.

Network 130 provides connectivity between server system 120 and client systems 150A-150N. Network 110 may be implemented using protocols such as Transmission Control Protocol (TCP) and/or Internet Protocol (IP), well known in the relevant arts. In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered.

Each of the client systems 150A-150N represents a system such as a personal computer, workstation, mobile station, etc., used by end users to generate (user) requests directed to business/enterprise applications executing in server system 120. The requests may be generated using appropriate user interfaces. In general, an end-user system requests an enterprise/server application for performing desired tasks and receives corresponding responses containing the results of performance of the requested tasks. Each request is sent in the form of an IP packet directed to the desired server system, with the IP packet including data identifying the desired tasks in the payload portion.

Each client system 150A-150N is shown containing a corresponding client application 140A-140N. The client applications execute in the respective client system, and provide a user interface (based on display and inputs such as keyboard and mouse) using which the corresponding user can interact with the client system and thus the enterprise application. The client application may correspond to a web browser operating based on standards such as HTML (wherein the intelligence is controlled by content received from server system 120), or alternatively to custom applications interacting with server system 120 according to pre-specified conventions. The users may be internal users such as employees/administrators of the business entity/organization or external users such as customers/vendors/suppliers of the business entity/organization.

Server system 120 represents a server, such as a web/application server, executing software applications (for example, benefits management application) capable of performing tasks requested by clients/users. In general, each server system receives requests for performing desired tasks from users using client system, performs the requested tasks on data maintained internally or on external data (for example, stored in data store 110) and then sends the result of performance of the tasks to the requesting client system.

Data store 110 represents a non-volatile (persistent) storage facilitating storage and retrieval of a collection of data by business/enterprise applications executing in server system 120. Data stores 110 may be implemented as a database server using relational database technologies and accordingly provide storage and retrieval of data using structured queries such as SQL (Structured Query Language). Alternatively, data store 180 may be implemented as a file server providing storage and retrieval of data in the form of files organized as one or more directories, as is well known in the relevant arts.

It may be appreciated that users may need to select some or several entities represented by the data in data store 110. Several aspects of the present invention provide for such selection, as described below with examples.

3. Entity Selection

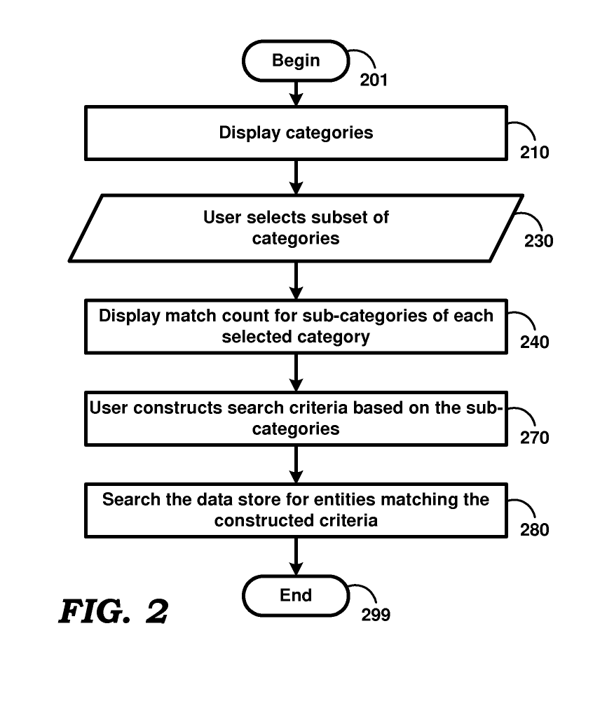

FIG. 2 is a flow chart illustrating the manner in which selection of entities is simplified according to an aspect of the present invention. The flowchart is described with respect to FIG. 1 merely for illustration. However, many of the features can be implemented in other environments also without departing from the scope and spirit of several aspects of the present invention, as will be apparent to one skilled in the relevant arts by reading the disclosure provided herein.

The flow chart begins in step 201, in which control passes to step 210. In step 210, client application 140A executing in client system 150A, displays (typically on a display unit/ monitor provided associated with the client system) data representing a set of categories. A category represents a higher level grouping of entities of interest sought to be searched for. The lower level groupings (further dividing the entities in the higher level) are referred to as sub-categories.

It should be generally appreciated that many entities span multiple categories, and thus there could be an overlap in terms of entities, between categories at the same level. Thus, the entities among (sub)categories at the same level can be mutually exclusive or have overlap. However, each sub-category can have entities only of the parent category. The categories may be displayed upon (or in response to) receiving corresponding data (in the form of packets originating) from server system 120 (directed to client application 140A).

In step 230, the user selects a subset of (i.e., some of) the displayed categories. To enable such selection, client application 140A may provide an appropriate convenient user interface using input devices such as keyboard and mouse, and output devices such as display units (monitors). Data representing the categories thus selected may be sent from application 140A to server system 120 (in packets directed to server system 120).

In step 240, client application 140A displays match count for sub-categories of the selected subset of categories. Match count represents the number of entities that match the criteria/condition(s) defining the sub-category. For example, assuming ‘gender’ to be a category and the system stores data indicating whether each person/entity is a male or a female (sub-categories), the displayed information may indicate the number of male and female persons respectively.

The match counts may be displayed upon receipt of the corresponding data from server system 120. By sending the data forming the basis for the display, server system 120 causes the display to be updated with the corresponding information. It should be appreciated that the entities (forming the basis for the respective counts) may be based on data stored in data store 110 (assuming all the data to be searched is stored within data store 110) and/or data available from external sources (e.g., other servers, etc., accessible via the Internet).

In step 270, user constructs search criteria based on the various sub-categories. In general, the search criteria is specified by one or more sub-categories, connected by logical operators (such as AND, OR, etc.). Due to the additional information available in terms of match counts for respective sub-categories, the user may be able to make more informed decisions in including (defined to cover excluding) specific sub-categories to construct search criteria. Client application 140A may be designed to provide a suitable interface for construction of the search criteria using at least some of the displayed sub-categories.

In step 280, the entities in data store 110 may be searched to identify the entities matching the search criteria. The matching entities in data store 110 may be identified and retrieved using any suitable retrieval techniques (for example structured queries such as SQL, etc., assuming data store 110 is implemented as a relational database) and the response (containing the matching entities) is sent to the client application 140A. The flowchart ends in step 299.

Thus, in enabling selection of entities, the user is able to work interactively (i.e., first specify criteria, view the matching counts, and then specify the search criteria using the sub-categories) with client application 140A, thereby having the benefit of pertinent information in constructing the search criteria.

It should be appreciated that the approach described above with respect to the flowchart can be implemented in various environments, with specific user interfaces suited for the corresponding environments. In an embodiment described below, the search criteria noted above is used to specify eligibility criteria (for selection of employees) in administration of benefits, as described below with an example.

4. Illustrative Example—Benefits Management System

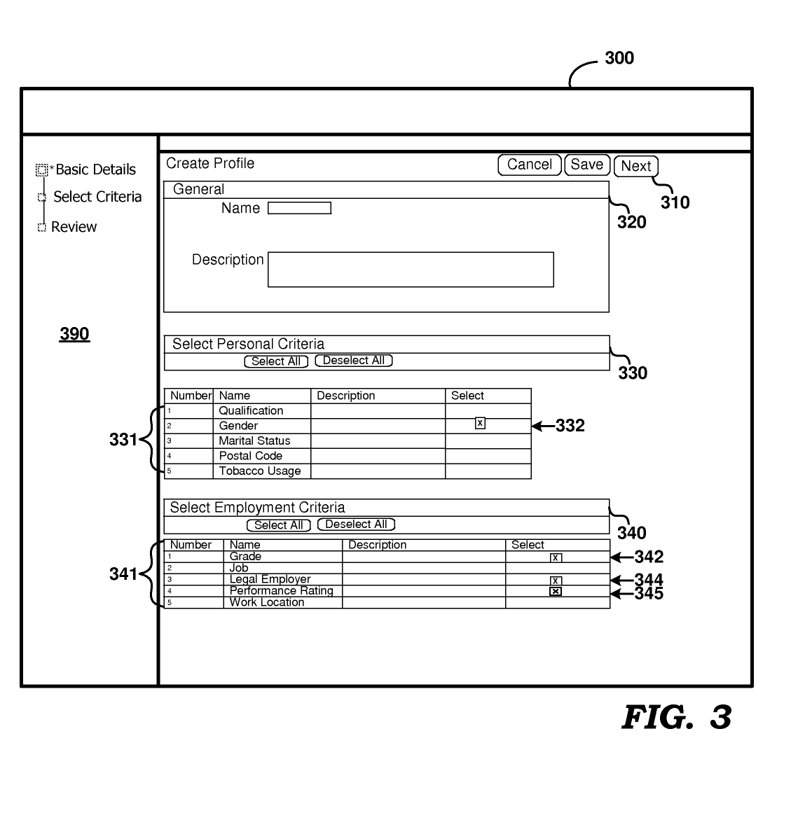

FIGS. 3-5 together illustrates the manner in which selection of entities is enabled interactively in one embodiment. Each of FIGS. 3-5, depicts respective user interface screens provided on a display unit (not shown) associated with a client system 150A from which a user accesses a benefits management system implemented for an enterprise based on server system 120 and data store 110. As will be apparent to one skilled in the relevant arts, the screens depict the interaction of a user with server system 120 based on web pages (or corresponding content) exchanged between server system 120 and client system 150A.

As may be readily appreciated, many enterprises have thousands of employees and there is a benefits administrator (sometimes a manager and sometimes specialists in human resources group). The benefits administrator (or any other person) is referred to as a user. The user interfaces with the benefits management system using client application 140A executed on client system 150A. Various aspects of the present invention enable the user to specify eligibility criteria (the specific employees to be included or excluded) for administering corresponding benefits, as described below in further detail.

FIG. 3 depicts the start screen displayed to a user seeking to specify an eligibility criteria. The user is provided with a set of five categories (331) in personal criteria 330 and a set of five categories (341) in employment criteria 340. The user is shown having selected Gender (as shown in 332) from categories 331 and Grade (as shown in 342), Legal Employer (as shown in 344) and Performance Rating (as shown in 345) from categories 341, as the interested subset of the displayed categories.

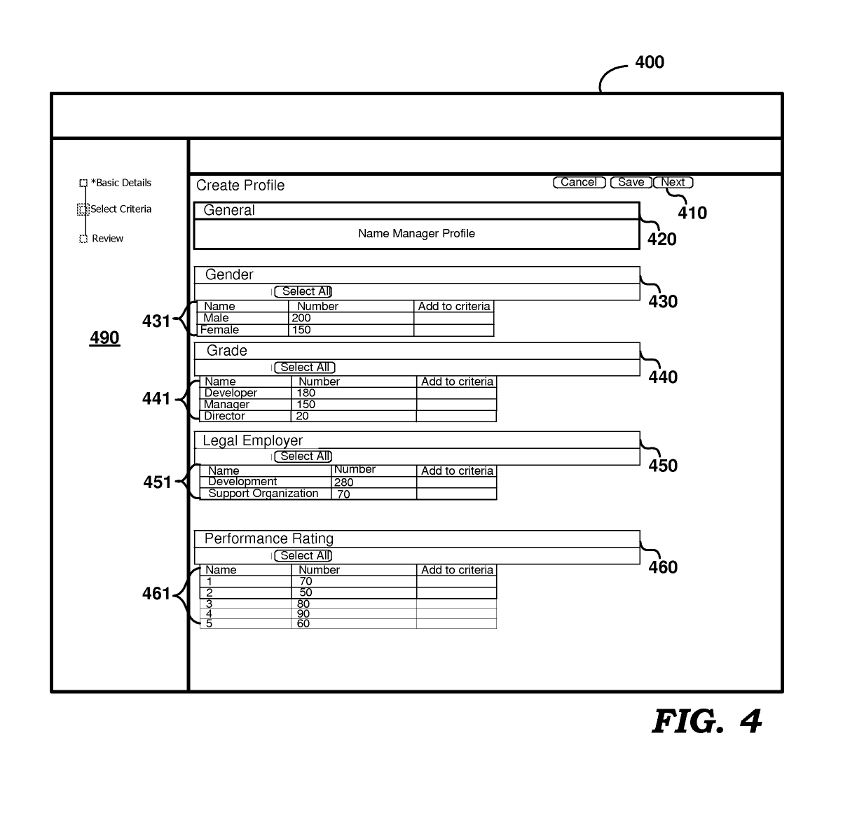

The selection of specific categories suggests that the user is possibly considering the corresponding sub-categories for eligibility criteria, with the match counts for the sub-categories being of potential interest in specifying the eventual eligibility criteria. User clicks ‘Next’ button 410 to navigate to the next screen of FIG. 4. As may be readily appreciated, the selection of the Next button causes data indicating selections at 332, 342, 344 and 345 to be sent to server system 120, which in response may update the user interface with the match counts corresponding to the sub-categories of the selected categories, as depicted with an example in FIG. 4.

FIG. 4 depicts the next screen displayed to the user on the display screen associated with client system 150A. The user interface there depicts the sub-categories for each of the categories selected in FIG. 3, in addition to the match count corresponding to each sub-category. Match count refers to the number of elements matching the condition (or criteria) forming the basis for division of a category into sub-categories. For example, in the case of ‘Gender’ category, ‘male’ and ‘female’ are the two sub-categories, and FIG. 4 indicates respective match counts of 200 and 150 (indicating the number of Male and female employees in that organization) in area 431. The match count information is displayed on the display screen as a response to receiving the corresponding data from server system 120.

Similarly sub-categories are displayed along with respective match counts corresponding to Grade (designation or role, at possibly different levels of the enterprise hierarchy), Legal employer (i.e., divisions within the enterprise) and Performance Rating (under-performer vs. high performer, etc., using appropriate number convention) categories, in areas 441, 451 and 461 respectively.

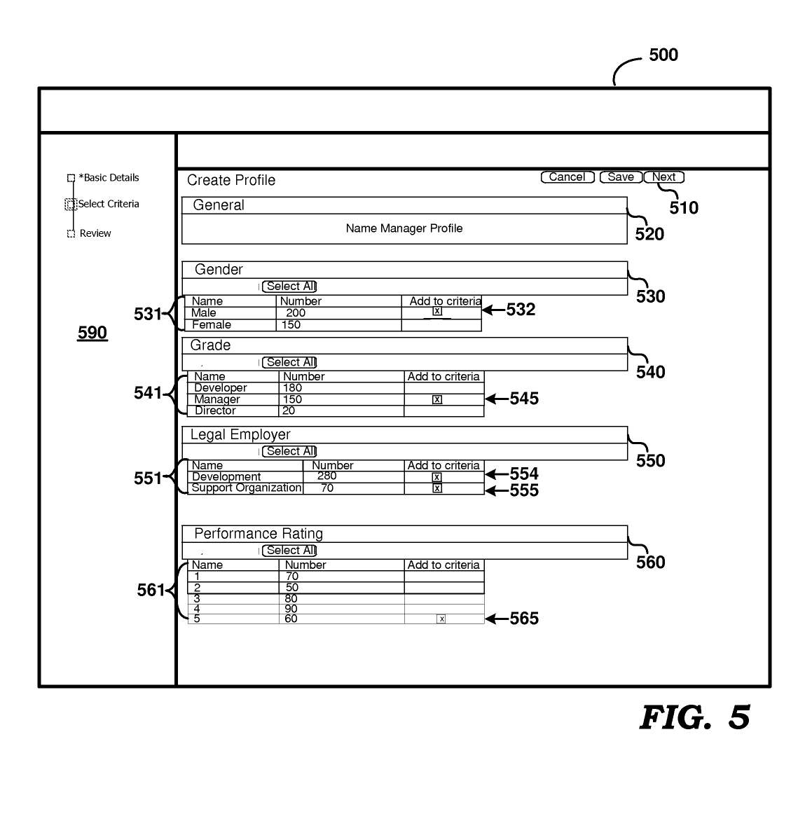

Having the benefit of match count for each of the sub-categories, a user may now make informed decision in constructing the eligibility criteria. In an embodiment, the user selects the specific sub-categories of interest, as depicted in FIG. 5.

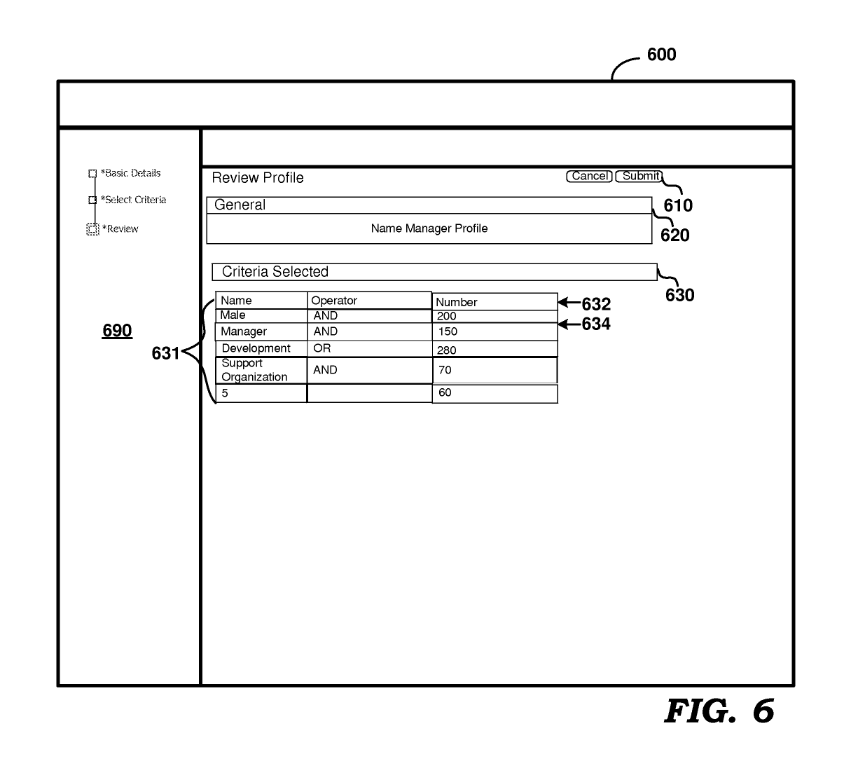

FIG. 5 depicts that the user has selected the following subcategories—Male as shown at 532, Manager as shown at 545, Development as shown at 554, Support Organization as shown at 555, ‘Performance Rating’ of 5 as shown at 565. The user may then click on Next button 510 to navigate to the next screen depicted in FIG. 6. As may be readily appreciated, the selection of the Next button causes data indicating selections at 532, 545, 554, 555 and 565 to be sent to server system 120, which in response may enable the user to specify the eligibility criteria based on the selected sub-categories (connected by logical operators) on the user interface, as depicted with an example in FIG. 6.

FIG. 6 depicts the manner in which user specifies the eligibility criteria based on the sub-categories selected in FIG. 5. Eligibility criteria specified is available for view in a tabular form with the ‘Name’ column indicating the selected sub-categories, ‘Operator’ column indicating any mathematical logical operators such as AND,OR, etc and ‘Number’ column indicating the match count corresponding to each selected sub-category. User is shown having operated effectively indicating the eligibility criteria—‘Male AND Manager AND (Development OR Support organization) AND 5’ as shown in 631. In other words, the user is specifying the search/eligibility criteria as all ‘male managers who are in the development or support roles, with a performance rating of 5’.

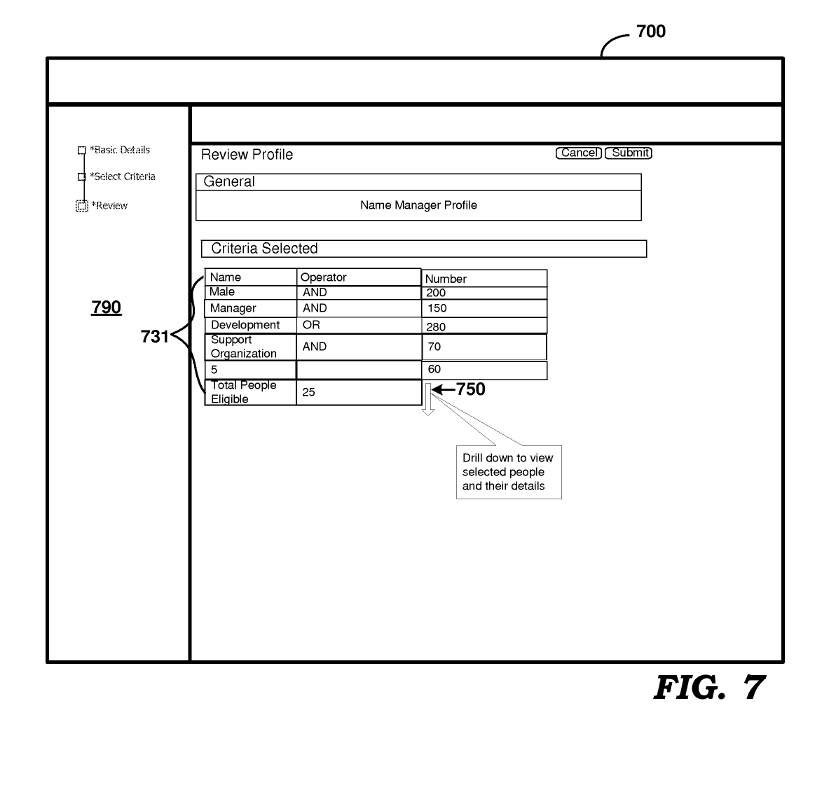

User clicks on Submit button 610 to cause a search instruction to be issued. The search instruction is sent from client system 150A to server system 120, which then conducts a search in data store 110 to determine the people matching the eligibility criteria specified. In an embodiment, the total number of people (eligible for the benefit), matching the eligibility criteria is sent (from server system 120) for display on the display screen associated with client system 150A. Accordingly, FIG. 7 (displayed in response to the ‘submit’ operation of FIG. 6) is shown displaying ‘Total People Eligible −25’ at 750 (indicating 25 people matched the eligibility/search criteria specified at FIG. 6).

User can click on area 750 to access the details of the selected eligible people (e.g., view or download the list of matching employees). User is also provided with an option to save the created eligibility profile by clicking on the save button shown in any of FIGS. 3-5. The profile thus saved can be retrieved using a suitable mechanism and a search instruction issued based on the same to cause the display (including the total people eligible) of FIG. 7.

Once the determined matching employees are displayed, a benefit can be conferred on such eligible people based on an appropriate user interface. For example, all the employees in such a list may be conferred a bonus of $5000 (or a percentage of their respective salary).

Thus the interaction selection provided according to several features of the present invention be used in administration of benefits. It should be appreciated that the features can be used for other purposes (e.g., for mere analysis of entities matching a desired search criteria).

It should be appreciated that the ‘user friendliness’ (of interactive selection) is enhanced when the responses from server system 120 are quick. For example, it is desirable that the screen of FIG. 4 be displayed soon (i.e., without substantial delay) after the next button 310 of FIG. 3 is selected (clicked on). An aspect of the present invention provides such a quick response, as described below in further detail.

5. Enhanced Speed for Interactivity

Sever system 120, in an embodiment, pre-computes the match counts corresponding to at least some of the sub-categories. Pre-computing implies that the match count is determined before the corresponding requests (e.g., that initiated upon selection of next button 310 of FIG. 3) are received by server system 120.

Pre-computing is generally appropriate for sub-categories where the underlying condition (forming the basis for categorization within the higher level category) does not change for the entities. For example, for the ‘Gender’ category, server system 120 may pre-compute the respective counts for ‘male’ and ‘female’ sub-categories.

Accordingly, when the search request is received based on selection of next button 310, server system 120 does not need to react to compute the corresponding counts, and instead can merely retrieve the pre-computed (and pre-stored) counts for providing the display of FIG. 4. Due to the absence of delay otherwise required for computation, the response of FIG. 4 can be provided quickly.

However, certain sub-categories may not be suited for such pre-computation. For example, sub-categories such as those based on age (which change every day/instance), may not be suitable for pre-computation. In such a scenario, if a search criteria specifies such a sub-category, server system 120 may retrieve and examine the corresponding data (of the entities) to determine the corresponding count.

While the above description is provided with respect to selection of people, various features of the invention can be applied to other types of entities (e.g., products, etc.), as will be apparent to one skilled in the relevant arts by reading the disclosure provided herein.

It should be appreciated that the features described above can be implemented in various embodiments as a desired combination of one or more of hardware, executable modules, and firmware. The description is continued with respect to an embodiment in which various features are operative when the software instructions described above are executed.

6. Digital Processing System

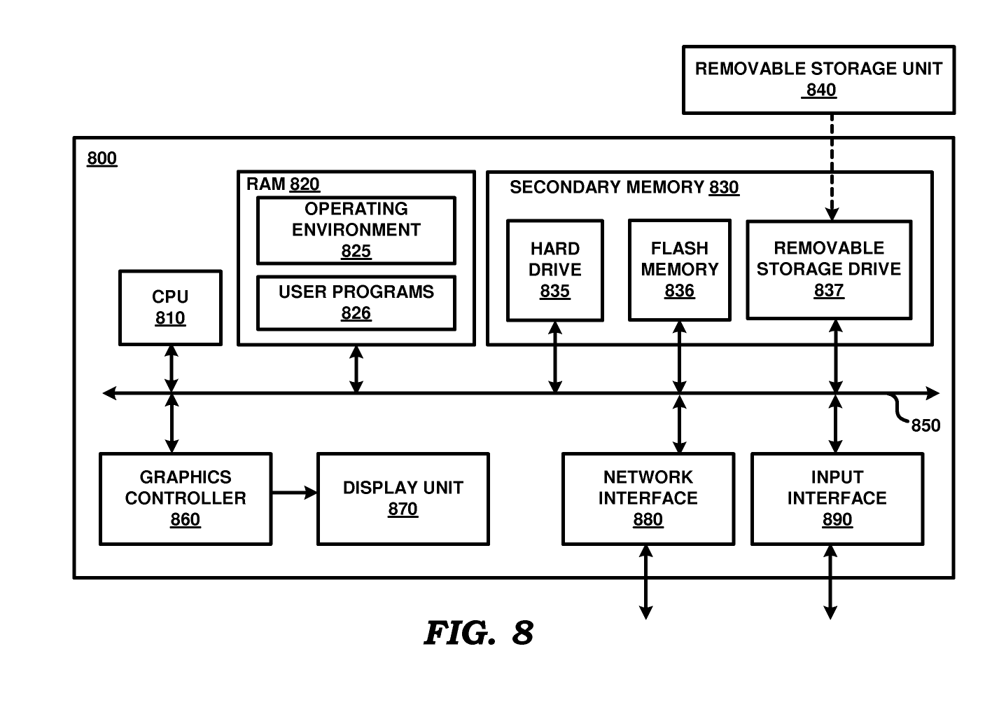

FIG. 8 is a block diagram illustrating the details of digital processing system 800 in which several aspects of the present invention are operative by execution of appropriate software instructions. Digital processing system 800 may correspond to any system (such as server system 120 or client system 150A) executing software applications (for example, benefits management system, noted above).

Digital processing system 800 may contain one or more processors (such as a central processing unit (CPU) 810), random access memory (RAM) 820, secondary memory 830, graphics controller 860, display unit 870, network interface 880, and input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present invention (e.g., the flow chart of FIG. 2, or the user interfaces of FIGS. 3-7 described above). CPU 810 may contain multiple processing units, with each processing unit potentially being designed for a specific task. Alternatively, CPU 810 may contain only a single general-purpose processing unit.

RAM 820 may receive instructions from secondary memory 830 using communication path 850. RAM 820 is shown currently containing software instructions constituting shared environment 825 and/or user programs 826 (such as networking applications, database applications, client application 140A, etc.). Shared environment 825 contains utilities shared by user programs, and such shared utilities include operating system, device drivers, virtual machines, flow engine, etc., which provide a (common) run time environment for execution of user programs/applications.

Graphics controller 860 generates display signals (e.g., in RGB format) to display unit 870 based on data/instructions received from CPU 810. Display unit 870 contains a display screen to display the images defined by the display signals (such as the user interface shown in FIGS. 3-7). Input interface 890 may correspond to a keyboard and a pointing device (e.g., touch-pad, mouse) and may be used to provide the user inputs required for several aspects of the present invention (such as those provided for interacting with the user interface shown in FIGS. 3-7). Network interface 880 provides connectivity to a network (e.g., using Internet Protocol), and may be used to communicate with other connected systems (such as client systems 150A-150N, server system 120 etc.) of FIG. 1.

Secondary memory 830 may contain hard drive 835, flash memory 836, and removable storage drive 837. Secondary memory 830 may store the data and software instructions (for example, for performing the steps of FIG. 2), which enable digital processing system 800 to provide several features in accordance with the present invention.

Some or all of the data and instructions may be provided on removable storage unit 840, and the data and instructions may be read and provided by removable storage drive 837 to CPU 810. Floppy drive, magnetic tape drive, CD-ROM drive, DVD Drive, Flash memory, removable memory chip (PCMCIA Card, EPROM) are examples of such removable storage drive 837.

Removable storage unit 840 may be implemented using medium and storage format compatible with removable storage drive 837 such that removable storage drive 837 can read the data and instructions. Thus, removable storage unit 840 includes a computer readable storage medium having stored therein computer software and/or data. However, the computer (or machine, in general) readable storage medium can be in other forms (e.g., non-removable, random access, etc.).

In this document, the term “computer program product” is used to generally refer to removable storage unit 840 or hard disk installed in hard drive 835. These computer program products are means for providing software to digital processing system 800. CPU 810 may retrieve the software instructions, and execute the instructions to provide various features of the present invention described above.

It should be understood that numerous specific details, relationships, and methods are set forth to provide a full understanding of the invention. For example, many of the functions units described in this specification have been labeled as modules/blocks in order to more particularly emphasize their implementation independence.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

7. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of enabling selection of entities, said method being implemented in a digital processing system, said method comprising:
sending data representing a plurality of categories for display on a client system providing a user interface for a user, wherein each of said categories has a corresponding set of sub-categories;
receiving from said client system, data representing selection of a subset of categories of said plurality of categories, wherein said subset of categories are specified by said user on said user interface as a part of indicating a desired search criteria;
updating said user interface, for each of the sub-categories of said subset of categories, with a corresponding match count, in response to the selection of the category by said user; and
enabling said user to construct a desired search criteria by including at least some of the displayed sub-categories,
wherein entities matching said desired search criteria are identified in response to issuance of a search instruction containing said desired search criteria.

2. The method of claim 1, wherein said digital processing system is a part of a benefits management system,
wherein said search criteria represents eligibility criteria for administering benefits,
wherein said entities comprise employees of an enterprise deploying said benefits management system,
wherein said eligibility criteria is used to select eligible employees for a corresponding benefit.

3. The method of claim 2, wherein said user interface is provided at said user system based on a display on a display unit and an input device.

4. The method of claim 1, further comprising:
pre-computing a match count corresponding to at least some of said sub-categories, wherein said pre-computing is performed before receiving said selection of said subset of sub-categories,
wherein said updating is based on the pre-computed match count when the corresponding category is indicated to be selected in said received data.

5. The method of claim 4, wherein said enabling comprises:
storing said desired search criteria in the form of a profile; and
facilitating said user to select said profile, wherein said search instruction is issued to said server system in response to said user selecting said profile.

6. The method of claim 5, wherein said desired search criteria comprises the included sub-categories connected by corresponding logical operators.

7. The method of claim 4, further comprising:
dynamically computing a match count corresponding to a second category if the corresponding match count is not pre-computed, wherein the match count is dynamically computed after receiving of said data if the data indicates that said second category is selected.

8. A non-volatile machine readable medium storing one or more sequences of instructions for causing a digital processing system to enable selection of entities, wherein execution of said one or more sequences of instructions by one or more processors contained in said digital processing system causes said digital processing system to perform the actions of:
sending data representing a plurality of categories for display on a client system providing a user interface for a user, wherein each of said categories has a corresponding set of sub-categories;
receiving from said client system, data representing selection of a subset of categories of said plurality of categories, wherein said subset of categories are specified by said user on said user interface as a part of indicating a desired search criteria;
updating said user interface, for each of the sub-categories of said subset of categories, with a corresponding match count, in response to the selection of the category by said user; and
enabling said user to construct a desired search criteria by including at least some of the displayed sub-categories,
wherein entities matching said desired search criteria are identified in response to issuance of a search instruction containing said desired search criteria.

9. The non-volatile machine readable medium of claim 8, wherein said digital processing system provides a benefits management system,
wherein said search criteria represents eligibility criteria for administering benefits,
wherein said entities comprise employees of an enterprise deploying said benefits management system,
wherein said eligibility criteria is used to select eligible employees for a corresponding benefit.

10. The non-volatile machine readable medium of claim 9, wherein said user interface is provided at said user system based on an input device and a display on a display unit.

11. The non-volatile machine readable medium of claim 8, further comprising:
pre-computing a match count corresponding to at least some of said sub-categories, wherein said pre-computing is performed before receiving said selection of said subset of sub-categories,
wherein said updating is based on the pre-computed match count when the corresponding category is indicated to be selected in said received data.

12. The non-volatile machine readable medium of claim 11, wherein said enabling comprises:
storing said desired search criteria in the form of a profile; and
facilitating said user to select said profile, wherein said search instruction is issued to said server system in response to said user selecting said profile.

13. The non-volatile machine readable medium of claim 12, wherein said desired search criteria comprises the included sub-categories connected by corresponding logical operators.

14. The non-volatile machine readable medium of claim 11, further comprising:
dynamically computing a match count corresponding to a second category if the corresponding match count is not pre-computed, wherein the match count is dynamically computed after receiving of said data if the data indicates that said second category is selected.

15. A digital processing system comprising:
a processor;
a random access memory (RAM);
a machine readable medium to store one or more instructions which when retrieved into said RAM and executed by said processor causes said digital processing system to perform the actions of:
sending data representing a plurality of categories for display on a client system providing a user interface for a user, wherein each of said categories has a corresponding set of sub-categories;
receiving from said client system, data representing selection of a subset of categories of said plurality of categories, wherein said subset of categories are specified by said user on said user interface as a part of indicating a desired search criteria;
updating said user interface, for each of the sub-categories of said subset of categories, with a corresponding match count, in response to the selection of the category by said user; and
enabling said user to construct a desired search criteria by including at least some of the displayed sub-categories,
wherein entities matching said desired search criteria are identified in response to issuance of a search instruction containing said desired search criteria.

16. The digital processing system of claim 15, wherein said digital processing system is a part of a benefits management system,
wherein said search criteria represents eligibility criteria for administering benefits,
wherein said entities comprise employees of an enterprise deploying said benefits management system,
wherein said eligibility criteria is used to select eligible employees for a corresponding benefit.

17. The digital processing system of claim 16, said actions further comprising:
pre-computing a match count corresponding to at least some of said sub-categories, wherein said pre-computing is performed before receiving said selection of said subset of sub-categories,
wherein said updating is based on the pre-computed match count when the corresponding category is indicated to be selected in said received data.

18. The digital processing system of claim 17, wherein said enabling comprises:
storing said desired search criteria in the form of a profile; and
facilitating said user to select said profile, wherein said search instruction is issued to said server system in response to said user selecting said profile.

19. The digital processing system of claim 18, wherein said desired search criteria comprises the included sub-categories connected by corresponding logical operators.

20. The digital processing system of claim 18, said actions further comprising:
dynamically computing a match count corresponding to a second category if the corresponding match count is not pre-computed, wherein the match count is dynamically computed after receiving of said data if the data indicates that said second category is selected.
